(19) United States
(12) Patent Application Publication
(10) Pub. No.: US 2001/0048537 A1
(43) Pub. Date: Dec. 6, 2001

(54) Device and method for monitoring signal direction in an optical communications network

(76) Inventors: Michael Sussman, Winchester, MA (US); Ian Turner, Stratham, NH (US)

Correspondence Address: William F. Esser, Esq., Jenkens & Gilchrist, P.C., 1445 Ross Avenue, Suite 3200, Dallas, TX, 75202-2799, US

(21) Appl. No.: 09/872,383

(22) Filed: May 31, 2001

Related U.S. Application Data
(60) Provisional application No. 60/208,481, filed on Jun. 2, 2000.

(51) Int. Cl. H04B 10/08; H04J 14/02

(52) U.S. Cl. 359/110; 359/127

(57) ABSTRACT

A method and device are disclosed for monitoring communication activity within an optical communications network. The device includes a pair of optical components for tapping optical signals transported across a fiber optic line in the optical communications network. At least one optical performance monitor (OPM) receives tapped signals from the pair of optical components. An optical switch, controlled by the OPM, selectively provides to the at least one OPM tapped signals corresponding to optical signals traveling on the fiber optic line in a first direction. The OPM measures the various signal characteristics of the tapped signals when the optical switch is opened and closed, and determines the direction of travel of optical signals on the fiber optic line based upon the measured signal characteristics.

### CROSS-REFERENCE TO RELATED APPLICATIONS

This patent application is related to and claims priority from U.S. patent application Ser. No. 60/208,481, filed Jun. 2, 2000 (Attorney Docket No. 34013-30USPL).

### BACKGROUND OF THE INVENTION

1. Technical Field of the Invention

The present invention relates to monitoring activity within an optical communications network, and particularly to a device and method for sensing the direction of optical signals within the optical communications network.

2. Description of the Related Art

The telecommunications industry has grown significantly in recent years due to developments in technology, including the Internet, e-mail, cellular telephones, and fax machines. These technologies have become affordable to the average consumer such that the volume of traffic on telecommunications networks has grown significantly. Furthermore, as the Internet has evolved, more sophisticated applications have increased the volume of data being communicated across the telecommunications networks.

To accommodate the increased data volume, the infrastructure of the telecommunications networks has been evolving to increase the bandwidth of the telecommunications networks. Fiber optic networks that carry wavelength division multiplexed optical signals provide for significantly increased data channels for handling the high volume of traffic. One component of the fiber optic network is an optical performance monitor (OPM), which is a spectrometer capable of measuring power and wavelength across a spectrum formed from the wavelength division optical signals. By measuring this signal characteristic, the OPM may be utilized to monitor the health of the telecommunications network.

One type of OPM is a focal plane array-based OPM. A typical focal plane array based OPM includes optical components that separate the wavelength division multiplexed optical signals into its constituent monochromatic or narrowband optical signals. The optical components of the focal plane array based OPM generally include lenses for focusing and collimating the optical signals, a diffraction grating for separating the wavelength division multiplexed optical signals to form a spatial representation of its discrete power spectrum, and a photo-diode array or other optical detector that converts the discrete power spectrum into electrical signals for subsequent analysis.

As optical communications networks have become more sophisticated and more heavily used, the demand for more closely monitoring activity within the optical communications network has increased to ensure messages communicated within the optical communications network are successfully received. Because some existing OPM devices may fail to provide a sufficient amount of information to accurately and reliably monitor all of the ever increasing activities occurring within an optical communications network, there is a need for an OPM device having enhanced network-monitoring capabilities.

### SUMMARY OF THE INVENTION

Embodiments of the present invention overcome shortcomings in prior optical communications networks and satisfy a significant need for a monitor device that monitors a variety of operating characteristics of the optical communications network.

In a first exemplary embodiment of the present invention, an optical monitor device is in optical communication with a fiber optic line of an optical communications network. The optical monitor device may include a first optical tap for placing onto a second fiber optic line a portion of optical signals transported over the fiber optic line in a first direction, and a second optical tap for placing onto a third fiber optic line a portion of signals transported over the fiber optic line in a second direction. A first optical switch is disposed in optical communication with the second fiber optic line and configurable in open and closed states. A tap coupler places onto a fourth fiber optic line optical signals generated at an output of the first optical switch and appearing on the third fiber optic line. An OPM measures power/energy levels and wavelengths of optical signals appearing on the fourth fiber optic line, generates a control signal for controlling the first optical switch and determines a direction of travel of signals transported along the fiber optic line based upon measurements obtained when the first optical switch is opened and closed. By monitoring the direction of travel of signals transported along the fiber optic line, the optical monitor device provides the ability to closely monitor operating characteristics of the optical communications network.

In a second exemplary embodiment of the present invention, a second optical switch is disposed in optical communication between the third and fourth fiber optic lines and configurable in open and closed states. The OPM measures carrier wavelengths and power/energy levels of optical signals appearing on the fourth fiber optic line, generates a second control signal for controlling the second optical switch, and determines whether a carrier wavelength of an optical signal transported along the first fiber optic line in the first direction is substantially the same as a carrier wavelength of an optical signal transported along the first fiber optic line in the second direction, based upon the power and wavelength measurements when the first and second optical switches are separately opened. Because optical signals having the same wavelength may undesirably interfere with each other due to signal reflections appearing on the fiber optic line over which the two optical signals travel, the optical monitor device is capable of detecting undesirable conditions in communicating optical signals in the optical communications network.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is a block diagram of an optical communications network including an optical monitor device according to exemplary embodiments of the present invention;

FIG. 2 is a diagram of the optical monitor device according to a first exemplary embodiment of the present invention;

FIG. 3 is a flow chart illustrating an operation of the optical monitor device of FIG. 2;

FIG. 4 is a diagram of the optical monitor device according to a second exemplary embodiment of the present invention;

FIG. 5 is a flow chart illustrating an operation of the optical monitor device of FIG. 4;

FIG. 6 is a diagram of the optical monitor device according to a third exemplary embodiment of the present invention;

FIG. 7 is a diagram of the optical monitor device according to a fourth exemplary embodiment of the present invention;

FIG. 8 is a flow chart illustrating an operation of the optical monitor device of FIG. 7; and

FIG. 9 is a diagram of the optical monitor device according to a fifth exemplary embodiment of the present invention.

### DETAILED DESCRIPTION OF THE PREFERRED EXEMPLARY EMBODIMENTS

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough and complete, and will fully convey the scope of the invention to those skilled in the art.

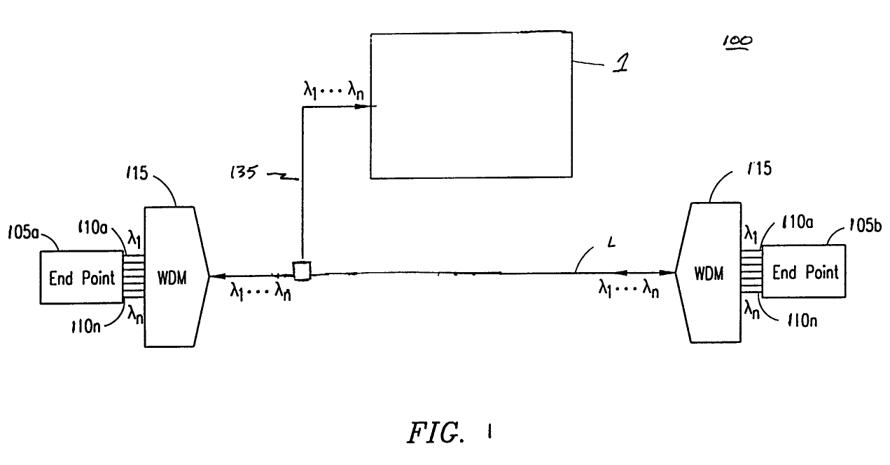

Referring to FIGS. 1-6 there is shown an optical monitor device 1 for monitoring signal characteristics of optical signals transported over a fiber optic line in an optical communications network 100. Optical monitor device 1 may, among other things, monitor and indicate the direction of optical signals transported over the fiber optic line and indicate whether signals traveling in opposite directions along the fiber optic line have the same carrier wavelength, as explained in greater detail below.

FIG. 1 illustrates an exemplary optical communications network 100 in which optical monitor device 1 may be disposed. Optical communications network 100 may include optical components commonly found in optical communications networks. For instance, the exemplary optical network 100 may include two end points 105a and 105b. The two end points may possibly represent two different cities that are in fiber optic communication with each other. At each city, a network operator may maintain fiber optic network equipment. At each end point 105a and 105b, a plurality of fiber optic lines 110a, 110b, . . . 110n, are capable of carrying narrowband optical signals having center wavelengths λ₁, λ₂, . . . , λₙ (i.e., λ₁-λₙ). The narrowband optical signals may, for example, have center wavelengths λ₁-λₙ within the range of at least the optical C-band (approximately 1520 nm to approximately 1566 nm) and/or L-band (approximately 1560 nm to approximately 1610 nm). Each narrowband optical signal in optical communications network 100 may be a time division multiplexed signal and may be wavelength division multiplexed with the other narrowband optical signals by a wavelength division multiplexer/demultiplexer 115.

An optical monitor device 1 may be coupled to a fiber optic line L in the optical communications network 100 so as to monitor signal characteristics, such as energy/power levels, center wavelength, and optical signal-to-noise-ratio of optical signals transported within optical communications network 100. In this way, optical monitor device 1 may be used to monitor ensure proper operation of equipment in optical communications network 100.

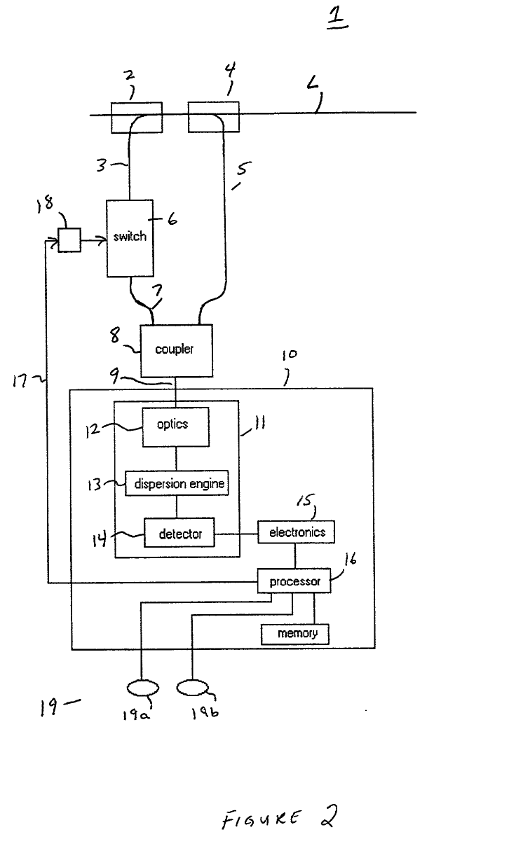

As stated above, optical monitor device 1 may include the capability to determine the direction of optical signals transported over fiber optic line L. Referring to FIG. 2, there is shown optical monitor device 1 according to a first exemplary embodiment of the present invention. In a first exemplary embodiment, optical monitor device 1 may include an optical tap or splitter 2 in optical communication with a fiber optic line L of optical communications network 100. Optical tap 2 taps a relatively small amount of power/energy from optical signals transported over fiber optic line L. For example, optical tap 2 may tap onto fiber optic line 3 approximately 1% of the power level of an optical signal appearing on fiber optic line L, thereby allowing approximately 99% of the power level of the optical signal on fiber optic line L for transmission to the desired destination. Optical tap 2 may be of the fused fiber type or other types known in the art. Optical tap 2 only taps optical signals transported over fiber optic line L in a first direction. In this case, optical tap 2 is only capable of tapping onto fiber optic line 3 westbound optical signals that are transported over fiber optic line L (i.e., optical signals that travel along fiber optic line L from right to left in FIG. 2).

Similarly, optical monitor device may include a second optical tap or splitter 4 in optical communication with fiber optic line L of optical communications network 100. Optical tap 4 also taps a relatively small amount of power/energy from optical signals transported over fiber optic line L. For example, optical tap 4 may tap onto fiber optic line 5 approximately 1% of the power level of an optical signal appearing on fiber optic line L, thereby allowing approximately 99% of the power level of the optical signal on fiber optic line L for transmission to the desired destination. Optical tap 4 may be of the fused fiber type or other types known in the art. Optical tap 4 only taps optical signals transported over fiber optic line L in a second direction. In this case, optical tap 4 is only capable of tapping onto fiber optic line 5 eastbound optical signals that are transported over fiber optic line L (i.e., optical signals that travel along fiber optic line L from left to right in FIG. 2).

Optical monitor device 1 may further include an optical switch 6 in optical communication with optical tap 2 so as to receive signals appearing on fiber optic line 3. Optical switch 6 is configurable in a closed state in which fiber optic line 7 is in optical communication with fiber optic line 3, and an open state in which fiber optic line 7 is decoupled from fiber optic line 3. Optical switch 6 may be of the mechanical type, such as an optical switch utilizing a movable mirror to selectively close and open an optical communication path. Optical switch 6 may also be of the electro-optical type, such as a switch employing electro-optical crystals. Optical switch 6 may also be an electro-optical modulator, such as optical switches of Lithium Niobate crystal composition. It is understood, however, that optical switch 6 may be implemented in other ways so as to provide an optical path that is selectively opened and closed. Optical switch 6 includes a control input for receiving a control signal to configure optical switch 6 into open and closed states.

A tap coupler 8 is disposed within optical monitor device 1 in optical communication with optical switch 6 and optical tap 4. Tap coupler 8 is adapted to combine energy tapped by optical taps 2 and 4 onto fiber optic line 9. Tap coupler 8 may be a fused 50% fused fiber.

Optical monitor device 1 may further include an optical performance monitor (OPM) 10 disposed in optical communication with tap coupler 8 so as to receive optical signals appearing on fiber optic line 9. The OPM 10 is capable of measuring one or more signal characteristics of optical signals, such as power, center wavelength and optical signal to noise ratio (OSNR), received by OPM 10. In this way, OPM 10 is utilized to monitor the operation of optical communications network 100.

The OPM 10 may have any of a number of different structural implementations, such as a scanning based OPM and a focal plane array based OPM. For illustrative purposes only, OPM 10 will be described below as a focal plane array based OPM.

OPM 10 may include a spectrometer 11 having optic components 12, such as collimating lenses, and a dispersion engine 13 for spatially dispersing a multiplexed optical input signal onto a detector array 14 having a plurality of optical detector elements and/or pixels. Detector array 14 is adapted to convert in parallel narrowband optical signals imaged thereon into electrical signals. Detector array 14 may, for example, be an indium gallium arsenide optical detector. Spectrometer 11 may further include various electronics 15 for suitably conditioning the electrical signals generated by detector array 14. Electronics 15 may include, for example, amplifier circuitry and analog-to-digital converter (ADC) circuitry. A processing unit 16 may receive signals generated by electronics 15 and perform various signal processing operations thereon, dependent upon the particular signal characteristics desired. Processing unit 16 may include a general purpose processor and corresponding memory having signal processing and/or signal measurement and recording software code stored therein. Processing unit 16 may alternatively be a digital signal processor (DSP). OPM 10, and particularly processing unit 16, may generate a control signal on a control line 17 that controls, configures or switches optical switch 6 between open and closed states. A line driver 18 may be disposed in optical monitor device 1 to receive the control signal appearing on control line 17 and provide buffering and/or conditioning to suitably drive the control input of optical switch 6.

The optical monitor device 1 may further include one or more light elements 19 coupled to receive drive signals from OPM 10. OPM 10, and particularly processing unit 16 therein, may generate the drive signals to indicate the direction of travel of optical signals transported on fiber optic line L and monitored by optical monitor device 1. Optical monitor device 1 may include, for instance, a first light element 19a, the illumination of which indicates signal travel in a first direction along fiber optic line L; and a second light element 19b, the illumination of which indicates signal travel in a second direction along fiber optic line L.

It is understood that light elements 19 may be disposed externally to optical monitor device 1. For instance, light elements 19 may be disposed on a wavelength division multiplexer/demultiplexer 115 in optical communications network 100 (FIG. 1).

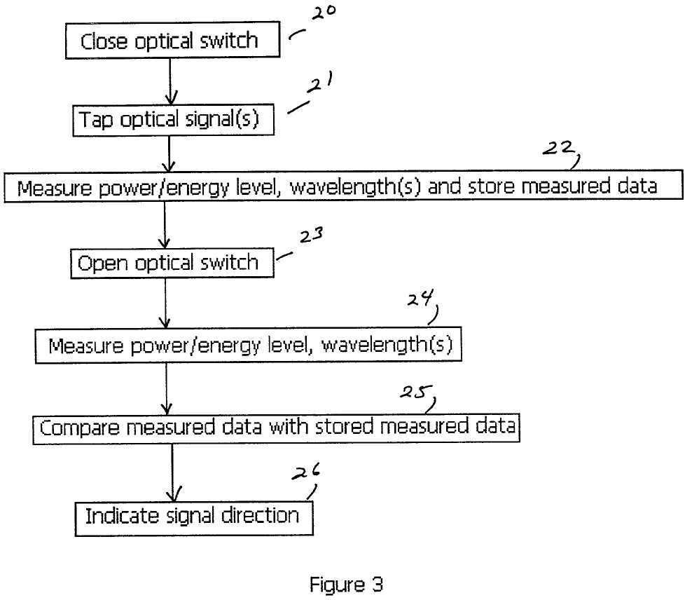

The operation of a optical monitor device 1 of FIG. 2 when determining signal direction will be described with reference to FIG. 3. Initially, optical switch 6 is closed by OPM 10 at 20. It is noted that optical switch 6 may be normally in the closed state and configured in the open state only when optical monitor device 1 is determining signal direction. Next, optical tap 2 and/or optical tap 4 tap one or more optical signals transported along fiber optic line L at 21. A tapped signal, having an energy level that is a fraction of the energy level of the corresponding optical signal transported on fiber optic line L, passes through tap coupler 8 and is received by OPM 10. OPM 10 may measure and store in memory at 22 energy/power level(s) and corresponding center wavelength(s) of the tapped optical signal.

OPM 10 may then open optical switch 6 at 23. Thereafter, one or more optical signals tapped by optical tap 4 are provided to OPM 10. OPM 10 measures at 24 energy/power level(s) and corresponding wavelength(s) in the tapped optical signal appearing on fiber optic line 9. Next, OPM 10, and particularly processing unit 16 therein, compares at 25 the stored energy/power level(s) with the corresponding energy/power level(s) recently measured at 24. For example, each stored energy/power level may be compared to the recently measured energy/power level at the same wavelength. If the comparison shows an appreciable power/energy difference, then OPM 10 concludes that the monitored optical signal transported on fiber optic line L is transported in the westbound direction (from right to left in FIG. 2). If the comparison shows little power difference, then OPM 10 concludes that the monitored optical signal transported on fiber optic line L is transported in the eastbound direction (from left to right in FIG. 2). Based upon the determination, OPM 10 may illuminate at 26 a light element 19 to indicate the direction of travel of the monitored optical signal. As can be seen, optical monitor device 1 of FIG. 2 may relatively accurately sense and indicate the direction of travel of optical signals appearing on fiber optic line L.

It is understood that signal measurements may be performed with optical switch 6 being in the open state prior to signal measurements being performed with optical switch 6 being in the closed state. In other words, signal direction determining may perform steps 23 and 24 before steps 20 and 22 in the operation described above.

It is also understood that optical monitor device 1 may include features in addition to signal direction sensing. It is noted that the optical monitor device 1 of FIG. 2 may, in some circumstances, be able to detect the presence of two optical signals transported on fiber optic line L in opposite directions and having a common carrier wavelength (hereinafter referred to as a “signal collision”). Because of signal reflections occurring in the fiber optic line, signal collisions may present difficulties in effectively communicating signals having a common wavelength on a single fiber optic line. Optical monitor device 1 of FIG. 2 may be unable to detect the presence of two optical signals transported on fiber optic line L having a common wavelength if the optical signals have substantially disproportionate power/energy levels at the common wavelength, such as a difference of 20db. Substantially disproportionate energy/power levels may be due to optical monitor device 1 being located proximally to a transmitter of eastbound optical signals and remotely located from a transmitter of westbound optical signals. For example, if the eastbound optical signal has a substantially greater energy/power level at the common wavelength than the energy/power level of the westbound optical signal at the common wavelength, the difference in the measured energy/power levels (one measurement being obtained when optical switch 6 is closed and another measurement being obtained when optical switch 6 is open) may be quite small and undetectable by detector array 14. Consequently, the optical performance monitor 1 of FIG. 2 may not reliably detect a signal collision in all possible scenarios.

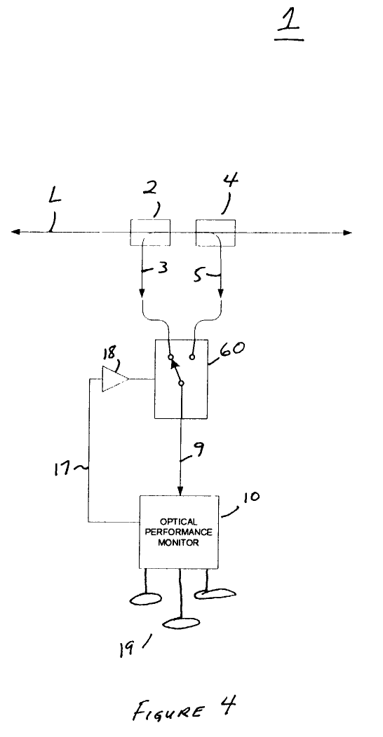

With reference to FIG. 4, there is shown optical monitor device 1 according to a second exemplary embodiment of the present invention. Optical monitor device 1 of FIG. 4 includes the capability to substantially reliably detect a signal collision of two separate optical signals transported on fiber optic line L. Specifically, optical monitor device 1 may include optical taps 2 and 4 and OPM 10 having the features/components described above with respect to the OPM 10 of FIG. 2 (i.e., spectrometer 11, electronics 15, processing unit 16 and memory). The OPM 10 is shown in FIG. 4 as a single block without the components shown in FIG. 2 for reasons of simplicity.

Optical monitor device 1 of FIG. 4 further includes a 1×2 optical switch 60 having a first input coupled to fiber optic line 3, a second input coupled to fiber optic line 5 and an output coupled to fiber optic line 9. Optical switch 60 is configurable in a first optic state in which fiber optic line 3 is in optical communication with fiber optic line 9, and a second optic state in which fiber optic line 5 is in optical communication with fiber optic line 9. Optical switch 60 may be viewed as an analog to a single pole double throw (SPDT) electrical switch. In particular, optical switch 60 includes a control input for switching optical switch 60 between the two optical states. OPM 10 generates a control signal on control line 17 that is provided to optical switch 60 (via buffer 18) to control the optical state thereof. By substantially regularly switching optical switch 60 between the two optical states, OPM 10 is capable of monitoring communication activity along fiber optic line L in both directions.

Optical monitor device 1 of FIG. 4 may determine the direction of travel of optical signals transported along fiber optic line L. For example, OPM 10 may configure optical switch 60 so that fiber optic lines 3 and 9 are in optical communication, and measure power/energy levels of westbound optical signals tapped by optical tap 2. Next, OPM 10 may configure optical switch 60 so that fiber optic lines 5 and 9 are in optical communication, and measure power/energy levels of eastbound signals tapped by optical tap 4. If an appreciable power/energy level(s) is detected by OPM 10 during the time westbound optical signals are tapped, then OPM 10 determines that the direction of travel of the optical signals on fiber optic line L is in the westbound direction and activates the light element 19 corresponding to detected westbound traffic. If an appreciable power/energy level(s) is detected by OPM 10 during the time eastbound optical signals are tapped, then OPM 10 determines that the direction of travel of the optical signals on fiber optic line L is in the eastbound direction activates the light element 19 corresponding to detected eastbound traffic.

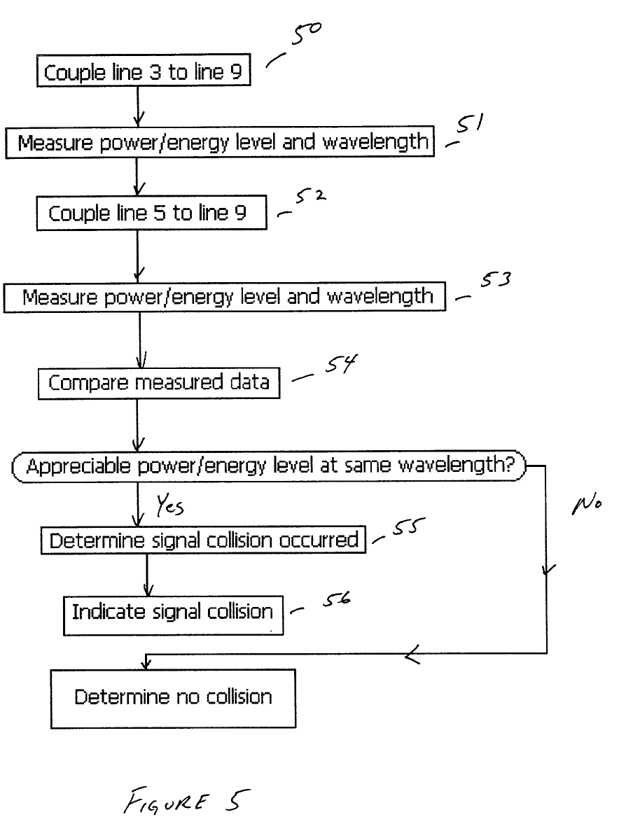

The operation of optical monitor device 1 of FIG. 4 in performing a signal collision detection operation will be described with respect to FIG. 5. Initially, OPM 10 may configure at 50 optical switch 60 so that fiber optic lines 3 and 9 are in optical communication. This causes a portion of any westbound optical signals on fiber optic line L to be delivered to OPM 10. Upon reception of the tapped, westbound optical signals, OPM 10 at 51 measures the power/energy levels and wavelengths thereof, and stores the measured power/energy levels and wavelengths in memory. Next, OPM 10 may configure at 52 optical switch 60 so that fiber optic lines 5 and 9 are in optical communication. This causes a portion of any eastbound optical signals on fiber optic line L to be delivered to OPM 10. Upon reception of the tapped, eastbound optical signals, OPM 10 at 53 measures the power/energy levels and wavelengths thereof, and stores the measured power/energy levels and wavelengths in memory. OPM 10 then may compare at 54 the data measured during 51 and 53. If an appreciable power/energy level was measured at both 51 and 53 for any one wavelength, OPM 10 determines at 55 that a signal collision has occurred. A light element 19 may be illuminated by OPM 10 at 56 that a signal collision was detected. In this way, optical monitor device 1 detects the occurrence of a signal collision along fiber optic line L.

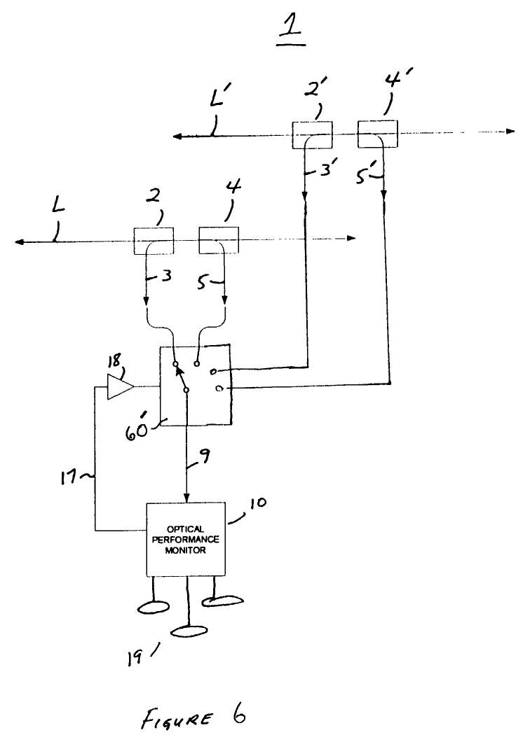

It is understood that optical monitor device 1 of FIG. 4 may be implemented to, among other things, detect signal collisions occurring on any of a plurality of fiber optic lines. As shown in FIG. 6, optical monitor device 1 monitors activities on two fiber optic lines, L and L′. A second pair of optical taps 2′ and 4′ tap westbound and eastbound optical signals on fiber optic line L′. In this case, optical switch 60′ is a 1×4 optical switch that is capable of optically coupling any of fiber optic lines 3, 5, 3′ and 5′ to fiber optic line 9. By OPM 10 substantially regularly or sequentially configuring optical switch 60′ into the four optical states (for individually coupling fiber optic lines 3, 5, 3′ and 5′ to fiber optic line 9), OPM 10 may be able to determine the direction of travel of signals appearing on fiber optical lines L and L′, and determine whether a signal collision occurs on fiber optic lines L and L′. It is understood that optical switch 60′ may be expanded to enable OPM 10 to monitor signal activity on more than two fiber optic lines. In general terms, with optical switch 60′ implemented as a 1×N switch, optical monitor device 1 is capable of monitoring signal activity on N/2 fiber optic lines.

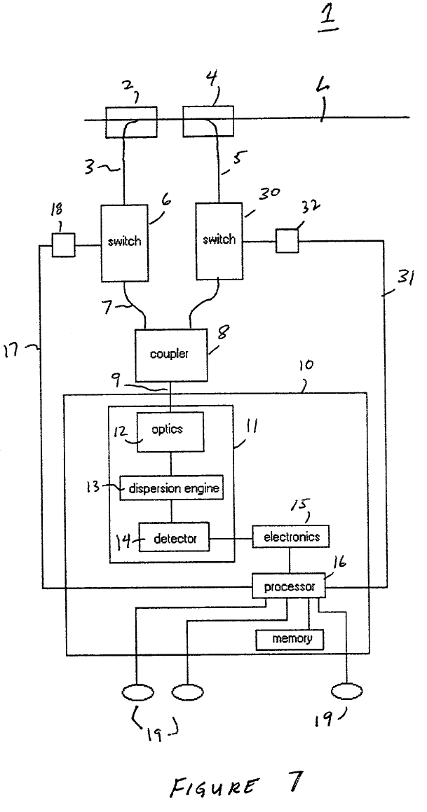

FIG. 7 illustrates optical monitor device 1 according to another exemplary embodiment of the present invention. Optical monitor device 1 of FIG. 7 includes a second optic switch 30 connected in optical communication between optical tap 4 and tap coupler 8. In addition to generating a control signal for controlling optical switch 6, OPM 10 generates a control signal on control line 31 for selectively opening and closing optical switch 30. A driver circuit 32 may be included to receive the control signal on control line 31 and drive the control input of optical switch 30. By including an optical switch along each optical path in optical monitor device 1, signal collision may be reliably detected.

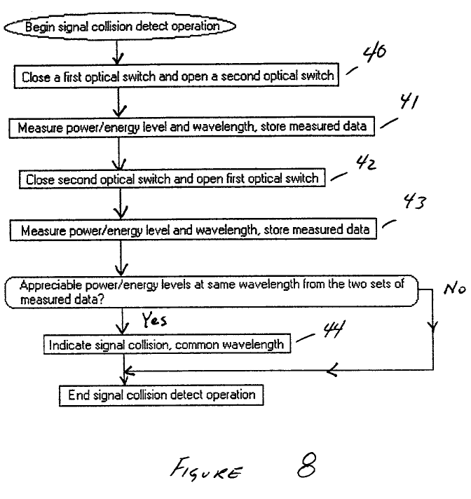

It is noted that optical monitor device 1 of FIG. 7 may control one of the optical switches 6 and 30 for performing a signal direction sensing operation, as described above with respect to optical monitor device 1 of FIG. 2. The operation of optical monitor device 1 of FIG. 7 in performing a signal collision detection operation will be described with respect to FIG. 8. Optical switches 6 and 30 are normally maintained in the closed position by OPM 10. Upon the start of a signal collision detection and direction sensing operation, OPM 10 opens a first one of the optical switches at 40 while maintaining the second one of the optical switches in the closed position. Next, OPM 10 measures and stores at 41 energy/power levels and corresponding carrier wavelengths of the optical signal appearing on fiber optic line 9 tapped by the optical tap corresponding to the closed optical switch. OPM 10 then closes the first one of the optical switches and opens the second one thereof at 42. Next, OPM 10 measures and stores at 43 energy/power levels and corresponding carrier wavelengths of the optical signal appearing on fiber optic line 9 tapped by the optical tap corresponding to the closed optical switch. OPM 10 then analyzes the data measured at 41 and 43. In the event that an appreciable energy/power level was measured at both 41 and 43 for any one wavelength, OPM 10 determines that a signal collision occurs. A light element 19, for example, may be illuminated by OPM 10 at 44 to indicate a signal collision. In addition or in the alternative, OPM 10 may indicate the particular wavelength at which an appreciable energy/power level was measured at both 41 and 43. In this way, optical monitor device 1 detects the occurrence of a signal collision along fiber optic line L.

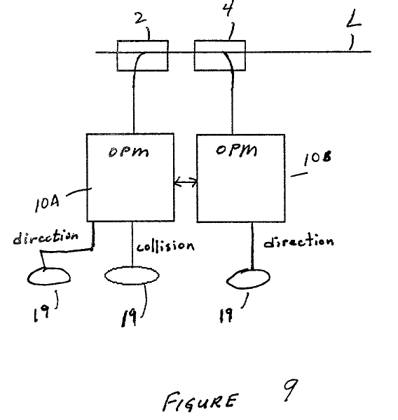

With reference to FIG. 9, there is shown optical monitor device 1 according to a third exemplary embodiment of the present invention. Optical monitor device 1 of FIG. 9 includes a optical taps 2 and 4 to tap optical signals transported along fiber optic line L in westbound and eastbound directions, respectively. Optical monitor device may further include a pair of OPMs 10. A first OPM 10A is in optical communication with optical tap 2 to receive optical signals representative of optical signals traveling in the westbound direction on fiber optic line L. A second OPM 10B is in optical communication with optical tap 2 to receive optical signals representative of optical signals traveling in the eastbound direction on fiber optic line L. Each OPM 10 is adapted to measure the power/energy level and wavelength of optical signals received from the optical tap associated with the OPM 10.

Because an OPM 10 only measures optical signals that are tapped from optical signals traveling in a single direction, optical switches and comparison operations are unnecessary to determine the direction of travel of optical signals appearing on fiber optic line L. An OPM 10 simply causes an associated light element 19 to illuminate when the OPM 10 senses an optical signal at the input thereof.

When the optical monitor device 1 of FIG. 9 performs a collision detection operation, OPMs 10 share with each other stored measurements of power/energy levels and wavelength for comparison purposes. In the event both OPMs measured power/energy levels at the same wavelength, such as for optical signals measured within a predetermined period of time, then a signal collision is found to have occurred and at least one of the OPMs 10 may illuminate a light element 19 to indicate the signal collision.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical device, comprising:
a pair of optical taps coupled to a fiber optic line, a first optical tap of the pair of optical taps tapping optical signals transmitted along the fiber optic line in a first direction and a second optical tap of the pair of optical taps tapping optical signals transmitted along the fiber optic line in a second direction; and
first means for receiving optical signals from the pair of optical taps and generating at least one signal indicative of a direction of travel of optical signals traveling along the fiber optic line.

2. The optical device of claim 1, wherein the first means comprises:
second means for determining whether a signal tapped by the first optical tap has a carrier wavelength that is the same as a carrier wavelength of a signal tapped by the second optical tap, and generating a signal indicative of the determination.

3. The optical device of claim 2, wherein the second means comprises:
a first monitor means for measuring signal characteristics of signals tapped by the first optical tap;
a second monitor means for measuring signal characteristics of signals tapped by the second optical tap; and
means for comparing the measured signal characteristics of signals tapped by the first optical tap with measured signal characteristics of signals tapped by the second optical tap.

4. The optical device of claim 2, wherein the second means comprises:
tap coupling means for coupling optical signals tapped from the first and second optical taps onto a second fiber optical line;
first switching means for selectively optically coupling the first optical tap to the tap coupling means;
second switching means for selectively optically coupling the second optical tap to the tap coupling means; and
monitor means for measuring signal characteristics of optical signals on the second fiber optic line while simultaneously individually controlling the first and second switching means to alternatively configure the first and second switching means between coupling and decoupling states.

5. The optical device of claim 4, wherein the monitor means controls the first and second switching means such that the monitor means measures optical signals appearing on the second fiber optic line while the first switching means is configured in the decoupling state, and measures optical signals appearing on the second fiber optic line while the second switching means is configured in the decoupling state.

6. The optical device of claim 1, wherein the second means comprises:
switching means for selectively and individually optically coupling the first optical tap and the second optical tap to a second fiber optic line; and
monitor means for measuring signal characteristics of optical signals on the second fiber optic line while simultaneously controlling the switching means to alternatingly couple the first and second optical taps to the second fiber optic line.

7. The optical device of claim 6, further comprising:
a second pair of optical taps coupled to a third fiber optic line, a first tap of the second pair of optical taps tapping optical signals transmitted along the third fiber optic line in a first direction and a second tap of the second pair of optical taps tapping optical signals transmitted along the third fiber optic line in a second direction;
wherein the switching means selectively and individually optically couples the first optical tap and the second optical tap of the second pair of optical taps to the second fiber optic line; and
the monitor means measures signal characteristics of optical signals on the third fiber optic line while simultaneously controlling the switching means to alternatingly couple the first and second optical taps of the second pair of optical taps to the second fiber optic line.

8. The optical device of claim 1, wherein the means for receiving and generating comprises:
tap coupling means for placing optical signals tapped by the first optical tap and optical signals tapped by the second optical tap onto a second fiber optic line;
switching means for selectively providing optical signals tapped by the first optical tap to the tap coupling means; and
monitor means for measuring signal characteristics of optical signals appearing on the second fiber optic line and controlling the switching means to alternatingly configure the switching means between coupled and decoupled states.

9. The optical device of claim 8, wherein the monitor means measures optical signals appearing on the second fiber optic line while the switching means couples the first optical tap to the coupling means, and measures optical signals appearing on the second fiber optic line while the switching means decouples the first optical tap from the coupling means.

10. A method for monitoring optical signals transported over a fiber optic line, comprising:
tapping optical signals transported over the fiber optic line;
detecting optical signals tapped during the step of tapping;
for each optical signal detected, determining a direction of travel along the fiber optic line of the optical signal corresponding to the detected optical signal; and
indicating each determined direction of travel.

11. The method of claim 10, wherein:
the step of tapping comprises tapping onto a second fiber optic line a portion of optical signals transported over the fiber optic line in a first direction, and tapping onto a third fiber optic line a portion of optical signals transported over the fiber optic line in a second direction;
the method further comprises selectively coupling the second fiber optic line onto a fourth fiber optic line, and substantially continuously coupling the third fiber optic line to the fourth fiber optic line; and
the step of detecting comprises detecting optical signals appearing on the fourth fiber optic line.

12. The method of claim 11, wherein the step of determining comprises:
measuring a power level of an optical signal appearing on the fourth fiber optic line when the second fiber optic line is decoupled from the fourth fiber optic line;
measuring a power level of an optical signal appearing on the fourth fiber optic line when the second fiber optic line is coupled to the fourth fiber optic line; and
comparing power levels measured during the time the second fiber optic line is decoupled from the fourth fiber optic line with power levels measured during the time the second fiber optic line is coupled to the fourth fiber optic line, the determined direction being based upon the comparison.

13. The method of claim 10, wherein:
the step of tapping comprises selectively tapping onto a second fiber optic line a portion of optical signals transported over the fiber optic line in a first direction, and selectively tapping onto a third fiber optic line a portion of optical signals transported over the fiber optic line in a second direction; and
the method further comprises determining whether a signal on the second fiber optic line has a carrier wavelength that is the same as carrier wavelength of a signal on the third fiber optic line, and generating a signal indicative of the determination.

14. The method of claim 13, further comprising:
during a first time period, selectively coupling the second fiber optic line to a fourth fiber optic line while decoupling the third fiber optic line from the fourth fiber optic line; and
during a second time period, selectively coupling the third fiber optic line to the fourth fiber optic line while decoupling the second fiber optic line from the fourth fiber optic line;
wherein the step of determining whether a signal on the second fiber optic line has a carrier wavelength that is the same as carrier wavelength of a signal on the third fiber optic line comprises:
measuring carrier wavelength of an optical signal appearing on the fourth fiber optic line during the first time period;
measuring carrier wavelength of an optical signal appearing on the fourth fiber optic line during the second time period; and
comparing the carrier wavelengths measured during the first time period with carrier wavelengths measured during the second time period.

15. The method of claim 13, wherein the step of determining whether a signal on the second fiber optic line has a carrier wavelength that is the same as carrier wavelength of a signal on the third fiber optic line comprises individually measuring the carrier wavelength of signals appearing on the second fiber optic line and the third fiber optic line, and comparing the measured carrier wavelengths.

16. The method of claim 10, wherein:
the step of tapping comprises selectively tapping onto a second fiber optic line a portion of optical signals transported over the fiber optic line in a first direction, selectively tapping onto the second fiber optic line a portion of optical signals transported over the fiber optic line in a second direction, selectively tapping onto the second fiber optic line a portion of optical signals transported over a third fiber optic line in a first direction, and selectively tapping onto the second fiber optic line a portion of optical signals transported over the third fiber optic line in a second direction; and
the method further comprises determining whether a signal on the fiber optic line in the first direction has a carrier wavelength that is the same as carrier wavelength of a signal on the fiber optic line traveling in the second direction, determining whether a signal on the third fiber optic line traveling in the first direction has a carrier wavelength that is the same as carrier wavelength of a signal on the third fiber optic line traveling in the second direction, and generating at lease one signal indicative of the determinations.

17. An optical device, comprising:
a first optical tap, coupled to a first fiber optic line, for placing onto a second fiber optic line a portion of optical signals transported over the fiber optic line in a first direction;
a second optical tap, coupled to the fiber optic line, for placing onto a third fiber optic line a portion of optical signals transported over the fiber optic line in a second direction;
a first optical switch in optical communication with the second fiber optic line and being configurable in open and closed states;
a tap coupler in optical communication with the first optical switch and the third fiber optic line, for placing onto a fourth fiber optic line optical signals generated at an output of the first optical switch and appearing on the third fiber optic line; and
an optical performance monitor coupled to the fourth fiber optic line and operable to measure power levels of optical signals appearing on the fourth fiber optic line, generate a control signal for configuring the first optical switch and determine a direction of travel of signals transported along the first fiber optic line based upon the power levels measured.

18. The optical device of claim 17, wherein:
the optical performance monitor measures power levels of optical signals appearing on the fourth fiber optic line during a first time period when the first optical switch is configured in a closed state and during a second time period when the first optical switch is configured in a open state.

19. The optical device of claim 18, wherein:
the optical performance monitor compares measured power levels of optical signals appearing on the fourth fiber optic line during the first time period with measured power levels of optical signals appearing on the fourth fiber optic line during the second time period, and indicates a direction of travel of signals transported along the first fiber optic line based upon the comparison.

20. The optical device of claim 17, further comprising:
a first light element; and
a second light element;
wherein the optical performance monitor activates the first light element when an optical signal transported on the first fiber optic line is determined to travel in a first direction, and activates the second light element when an optical signal transported on the first fiber optic line is determined to travel in a second direction.

21. An optical device, comprising:
a first optical tap, coupled to a first fiber optic line, for placing onto a second fiber optic line signals transported over the fiber optic line in a first direction;
a second optical tap, coupled to the fiber optic line, for placing onto a third fiber optic line signals transported over the fiber optic line in a second direction;
a first optical switch in optical communication with the second fiber optic line and being configurable in open and closed states;
a second optical switch in optical communication with the third fiber optic line and being configurable in open and closed states;
a tap coupler in optical communication with the first and second optical switches, for placing onto a fourth fiber optic line optical signals generated at an output of each of the first and second optical switches; and
an optical performance monitor coupled to the fourth fiber optic line and operable to measure carrier wavelengths of optical signals appearing on the fourth fiber optic line, generate a first control signal for controlling the first optical switch and a second control signal for controlling the second optical switch, and determine whether a carrier wavelength of an optical signal transported along the first fiber optic line in the first direction is substantially the same as a carrier wavelength of an optical signal transported along the first fiber optic line in the second direction.

22. The optical device of claim 21, wherein:
the optical performance monitor indicates a result of the determination.

23. The optical device of claim 22, further comprising:
a first light element, wherein the optical performance monitor activates the first light element upon an affirmative determination that a carrier wavelength of an optical signal transported along the first fiber optic line in the first direction is substantially the same as a carrier wavelength of an optical signal transported along the first fiber optic line in the second direction.

24. The optical device of claim 21, wherein:
the optical performance monitor measures carrier wavelengths of an optical signal appearing on the fourth fiber optic line during a first time period when the first optical switch is configured in a closed state and the second optical switch is configured in a open state, measures carrier wavelengths of an optical signal appearing on the fourth fiber optic line during a second time period when the second optical switch is configured in a closed state and the first optical switch is configured in a open state, and compares the carrier wavelengths measured during the first time period with carrier wavelengths measured during the second time period.

25. The optical device of claim 21, wherein:
the optical performance monitor measures power levels of optical signals appearing on the fourth fiber optic line, and determines a direction of travel of an optical signal on the fiber optic line based upon measured power levels.

26. The optical device of claim 25, wherein:
the optical performance monitor measures a power level of an optical signal appearing on the fourth fiber optic line during a first time period when the first optical switch is configured in the open state and the second optical switch is configured in the closed state and during a second time period when the first and second optical switches are configured in the closed state, and compares the power level measured during the first time period with power level measured during the second time period.

27. The optical device of claim 25, further comprising:
a first light element; and
a second light element;
wherein the optical performance monitor activates the first light element upon an affirmative determination that the optical signal is transported along the first fiber optic line in the first direction, and activates the second light element upon an affirmative determination that the an optical signal is transported along the first fiber optic line in the second direction.

28. An optical device for an optical communications system, comprising:
a first optical tap, coupled to a first fiber optic line, for placing onto a second fiber optic line a portion of signals transported over the fiber optic line in a first direction;
a second optical tap, coupled to the fiber optic line, for placing onto a third fiber optic line a portion of signals transported over the fiber optic line in a second direction;
a first optical performance monitor in optical communication with the second fiber optic and operable to measure optical signals appearing on the second fiber optic line; and
a second optical performance monitor in optical communication with the third fiber optic line and operable to measure optical signals appearing on the third fiber optic line, the first and second optical performance monitors determining a direction of travel of optical signals transported along the first fiber optic line.

29. The optical device of claim 28, further comprising:
a first light element; and
a second light element;
wherein the first optical performance monitor activates the first light element when the determined direction of travel along the fiber optic line is in a first direction, and the second optical performance monitor activates the second light element when the determined direction of travel along the fiber optic line is in a second direction.

30. The optical device of claim 28, wherein the first and second optical performance monitors determine whether a wavelength of an optical signal transported over the fiber optic line in the first direction is the same as a wavelength of an optical signal transported over the fiber optic line in the second direction, based upon the optical signals measured by the first and second optical performance monitors.

31. An optical device, comprising:
a first optical tap, coupled to a first fiber optic line, for placing onto a second fiber optic line signals transported over the fiber optic line in a first direction;
a second optical tap, coupled to the first fiber optic line, for placing onto a third fiber optic line signals transported over the fiber optic line in a second direction;
an optical switch having inputs in optical communication with the second and third fiber optic lines and being configurable to selectively and individually optically couple the second and third fiber optic lines to a fourth fiber optic line; and
an optical performance monitor coupled to the fourth fiber optic line and operable to measure carrier wavelengths of optical signals appearing on the fourth fiber optic line, generate a control signal for controlling the optical switch, and determine whether a carrier wavelength of an optical signals transported along the first fiber optic line in the first direction is substantially the same as a carrier wavelength of an optical signal transported along the first fiber optic line in the second direction.

32. The optical device of claim 31, wherein:
the optical performance monitor indicates a result of the determination.

33. The optical device of claim 31, wherein:
the optical performance monitor measures carrier wavelengths of an optical signal appearing on the fourth fiber optic line during a first time period when the optical switch is configured to optically couple the second and fourth fiber optic lines, measures carrier wavelengths of an optical signal appearing on the fourth fiber optic line during a second time period when the optical switch is configured in a state to optically couple the third and fourth fiber optic lines, and compares the carrier wavelengths measured during the first time period with carrier wavelengths measured during the second time period.
